(19) United States
(12) Patent Application Publication
(10) Pub. No.: US 2013/0227702 A1
(43) Pub. Date: Aug. 29, 2013

(54) SYSTEM AND METHOD FOR SYNTAGMATICALLY MANAGING AND OPERATING CERTIFICATION USING ANONYMITY CODE AND QUASI-PUBLIC SYNTAGMATIC CERTIFICATION CENTER

(71) Applicant: Yong Deok JUN, Goyang-si (KR)

(72) Inventor: Yong Deok JUN, Goyang-si (KR)

(21) Appl. No.: 13/451,309

(22) Filed: Apr. 19, 2012

(30) Foreign Application Priority Data
Feb. 27, 2012 (KR) 10-2012-0019770

(51) Int. Cl. G06F 21/24

(52) U.S. Cl. 726/26

(57) ABSTRACT

A method for syntagmatically managing and operating certification using an anonymity code is provided, which includes causing a quasi-public syntagmatic certification center to receive basic information including a terminal identification number when the terminal requests certification, causing the quasi-public syntagmatic certification center to detect whether there is an identity between a first resultant code and a preset corresponding anonymity code, causing the quasi-public syntagmatic certification center to determine whether to perform the certification with respect to the certification request depending on whether there is the identity between the first resultant code and the anonymity code, and causing the quasi-public syntagmatic certification center to send the certification result to the user terminal as a reply.

### CROSS-REFERENCE TO RELATED APPLICATION

This application is based on and claims priority from Korean Patent Application No. 10-2012-0019770, filed on Feb. 27, 2012 in the Korean Intellectual Property Office, the disclosure of which is incorporated herein in its entirety by reference.

### BACKGROUND OF THE INVENTION

1. Field of the invention

The present invention relates to a system and method for syntagmatically managing and operating certification using an anonymity code, and a quasi-public syntagmatic certification center. More particularly, the present invention relates to a system and method for syntagmatically managing and operating certification using an anonymity code, and a quasi-public syntagmatic certification center, in which the quasi-public syntagmatic certification center performs certification by using a response result received in response to whether there is an identity between a resultant code, which is obtained through setting combination between a private basic key found by a functionality dependent relationship with a terminal identification number and a preset center basic key, and a preset corresponding anonymity code, and position information, which are sent to a sub lower certification center, and if more detailed certification is required (for example, during financial transactions), the quasi-public syntagmatic certification center performs the certification by additionally requesting body information (for example, iris, fingerprint, and face image information) of the corresponding user, and which do not cause a user any inconvenience even if the user does not know any personal information during the certification and reduce a risk according to the certification process since it is not necessary for a company to have personal information that impose a burden thereon.

2. Description of the Prior Art

According to a typical certification system as described in Korean Patent Application No. 10-2007-0093885, personal information (for example, address information, a resident registration number, a mobile phone number, a company name, and an account number) is distributed for the corresponding personal information and is registered in a predetermined certification authority that is independently operated, and the certification is performed depending on the identity between personal information that is input to the certification authority and the registered personal information.

However, such a typical certification system using the personal information causes the following problems.

1. If the personal identification information of the commonly used basic key concept is open to the public or is abused by one mistake, although the personal identification information has been kept well, a risk still exist even if it is intended to use a substitute basic key.

2. Since the current system utilizes the basic key of the functionality dependent concept that is the basic concept of database as identifiable information, there are many risks that the database network becomes accessible through information obtained illegally or accidentally on offline (for example, ATP attack, social engineering hacking, or the like).

3. A verification method with login record is limited.

4. From a person standpoint, it is required to memorize IDs or passwords to cause inconvenience, while from a company standpoint, it is required to store client's personal information to cause inconvenience and risks.

5. It is not possible to prevent in advance personal information transactions between companies.

6. It is difficult to process an emergency state promptly, legally, and rationally on offline, and thus the fairness and transparency of an administrative service deteriorate.

### SUMMARY OF THE INVENTION

Accordingly, the present invention has been made to solve the above-mentioned problems occurring in the related art while advantages achieved by the related art are maintained intact.

A subject to be achieved by the present invention is to provide a system and method for syntagmatically managing and operating certification using an anonymity code, and a quasi-public syntagmatic certification center, which do not cause a user any inconvenience even if the user does not know any personal information during certification and reduce a risk according to a certification process since it is not necessary for a company to have personal information that impose a burden thereon.

In one aspect of the present invention, there is provided a method for syntagmatically managing and operating certification using an anonymity code, which includes causing a quasi-public syntagmatic certification center to receive basic information including a terminal identification number from a user terminal when the user terminal requests certification; causing the quasi-public syntagmatic certification center to detect whether there is an identity between a first resultant code, which is obtained through setting combination between a private basic key obtained from the received terminal identification number and a preset center basic key, and a preset corresponding anonymity code; causing the quasi-public syntagmatic certification center to determine whether to perform the certification with respect to the certification request from the user terminal depending on whether there is the identity between the detected first resultant code and the anonymity code; and causing the quasi-public syntagmatic certification center to send the determined certification result to the corresponding user terminal as a reply.

Preferably, the basic information may further include position information of the corresponding user terminal in addition to the terminal identification number, and the method according to the aspect of the present invention may further include causing the quasi-public syntagmatic certification center to transfer the position information to a lower certification center; causing the lower certification center to extract a response code depending on whether there is an identity between the position information and position information of the corresponding user that is detected by the corresponding lower certification center; causing the quasi-public syntagmatic certification center to determine whether to perform the certification with respect to the certification request from the user terminal depending on whether there is an identity between a second resultant code, which is obtained according to a functionality dependent relationship using the extracted response code, and the preset corresponding anonymity code and whether there is the identity between the first resultant code and the anonymity code; and sending the determined certification result to the corresponding user terminal as the reply.

Further, the method according to the aspect of the present invention may further include causing the quasi-public syntagmatic certification center to request body information of the corresponding user from the terminal in the case where the quasi-public syntagmatic certification center receives a company identification number from a specified terminal and determines that more detailed certification is required from a company identifiable information that is mapped on the received company identification number; causing the quasi-public syntagmatic certification center to transfer the body information of the corresponding user that is received as the request result to a lower certification center; causing the lower certification center to extract a response code depending on whether there is an identity between the transferred body information of the corresponding user and pre-registered body information of the corresponding user; causing the quasi-public syntagmatic certification center to determine whether to perform the certification with respect to the certification request from the user terminal depending on whether there is an identity between a third resultant code, which is obtained according to a functionality dependent relationship using the extracted response code, and the preset corresponding anonymity code and whether there is the identity between the first resultant code and the anonymity code; and informing the user of the determined certification result through sending of the determined certification result to the terminal through the quasi-public syntagmatic certification center.

Preferably, the body information may include at least one of iris, fingerprint, and face image information, and the anonymity code may include a country code to which a corresponding person belongs and an identification code of the corresponding person, and may be mapped on the basic information to be stored.

Further, the method according to the aspect of the present invention may further include, after sending the determined certification result to the corresponding user terminal as a reply, sending registered address information of the corresponding user whose certification is successful to the terminal as a reply in the case where the determined certification result is successful and the quasi-public syntagmatic certification center receives product transaction information, which includes transaction time information and a company identification number that requests the certification or is requested to perform the certification, from a specified terminal.

Preferably, information transmission/reception between the user terminal and the quasi-public syntagmatic certification center and information transmission/reception between the quasi-public syntagmatic certification center and the lower certification center may be performed using a communication protocol in which corresponding anonymity information is coded onto a header portion instead of the personal information.

In another aspect of the present invention, there is provided a system for syntagmatically managing and operating certification using an anonymity code, which includes a user terminal; and a quasi-public syntagmatic certification center receiving basic information including a terminal identification number from a user terminal when the user terminal requests certification, determining whether to perform the certification with respect to the certification request from the user terminal depending on whether there is an identity between a first resultant code, which is obtained through setting combination between a private basic key obtained from the received terminal identification number and a preset center basic key, and a preset corresponding anonymity code, and sending the determined certification result to the corresponding user terminal as a reply.

Preferably, the basic information may further include position information of the corresponding user terminal in addition to the terminal identification number, and the system according to the aspect of the present invention may further include a first lower certification center extracting a response code depending on whether there is an identity between the position information transferred from the quasi-public syntagmatic certification center and position information of the corresponding user that is detected by the corresponding lower certification center, wherein the quasi-public syntagmatic certification center determines whether to perform the certification with respect to the certification request from the user terminal depending on whether there is an identity between a second resultant code, which is obtained according to a functionality dependent relationship using the extracted response code, and the preset corresponding anonymity code and whether there is the identity between the first resultant code and the anonymity code, and sends the determined certification result to the corresponding user terminal as the reply.

Further, the system according to the aspect of the present invention may further include a second lower certification center extracting a response code depending on whether there is an identity between the body information of the corresponding user that is transferred from the quasi-public syntagmatic certification center and pre-registered body information of the corresponding user, wherein the quasi-public syntagmatic certification center requests the body information of the corresponding user from the terminal in the case where the quasi-public syntagmatic certification center receives a company identification number from a specified terminal and determines that more detailed certification is required from a company identifiable information that is mapped on the received company identification number, transfers the body information of the corresponding user that is received as the request result to the lower certification center, determines whether to perform the certification with respect to the certification request from the user terminal depending on whether there is an identity between a third resultant code, which is obtained according to a functionality dependent relationship using the response code extracted by the second lower certification center, and the preset corresponding anonymity code and whether there is the identity between the first resultant code and the anonymity code, and informs the user of the determined certification result through sending of the determined certification result to the terminal.

Preferably, the body information may include at least one of iris, fingerprint, and face image information, and the anonymity code may include a country code to which a corresponding person belongs and an identification code of the corresponding person, and may be mapped on the basic information to be stored.

Further, the quasi-public syntagmatic certification center may send registered address information of the corresponding user whose certification is successful to the terminal as a reply in the case where the determined certification result is successful and product transaction information, which includes transaction time information and a company identification number that requests the certification or is requested to perform the certification, is received from a specified terminal system, after sending the determined certification result to the corresponding user terminal as a reply.

Preferably, the system according to the aspect of the present invention may further include a judicial authority certification monitoring center performing a certification information monitoring operation for monitoring and tracking the position of the corresponding user by using the information certified by the quasi-public syntagmatic certification center.

Further, information transmission/reception between the user terminal and the quasi-public syntagmatic certification center and information transmission/reception between the quasi-public syntagmatic certification center and the lower certification center may be performed using a communication protocol in which corresponding anonymity information is coded onto a header portion instead of the personal information.

In still another aspect of the present invention, there is provided a quasi-public syntagmatic certification center, which includes an anonymity code detection unit detecting whether there is an identity between a first resultant code, which is obtained through setting combination between a private basic key obtained from a terminal identification number received from a corresponding user terminal when the user terminal requests certification and a preset center basic key, and a preset corresponding anonymity code; a first user certification unit determining whether to perform the certification with respect to the certification request from the user terminal depending on whether there is the identity between the detected first resultant code and the anonymity code; and a certification result reply unit sending the determined certification result to the corresponding user terminal as a reply.

Preferably, the basic information may further include position information of the corresponding user terminal in addition to the terminal identification number, and the quasi-public syntagmatic certification center according to the aspect of the present invention may further include a second user certification unit system determining whether to perform the certification with respect to the certification request from the user terminal depending on whether there is an identity between a second resultant code, which is obtained according to a functionality dependent relationship using a response code that is extracted depending on whether there is an identity between the position information transferred from the quasi-public syntagmatic certification center and position information of the corresponding user that is detected by the corresponding lower certification center, and the preset corresponding anonymity code and whether there is the identity between the first resultant code and the anonymity code, and sending the determined certification result to the corresponding user terminal through the certification result reply unit as the reply.

Further, the quasi-public syntagmatic certification center according to the aspect of the present invention may further include a detailed certification determination module requesting body information of the corresponding user from the terminal in the case where a company identification number is received from a specified terminal and it is determined that more detailed certification is required from a company identifiable information that is mapped on the received company identification number; and a third user certification unit transferring the body information of the corresponding user that is received as the request result to a second lower certification center, determining whether to perform the certification with respect to the certification request from the user terminal depending on whether there is an identity between a third resultant code, which is obtained according to a functionality dependent relationship using a response code that is extracted by the second lower certification center depending on whether there is an identity between the transferred body information of the corresponding user and pre-registered body information of the corresponding user, and the preset corresponding anonymity code and whether there is the identity between the first resultant code and the anonymity code, and informing the user of the determined certification result through sending of the determined certification result to the terminal through the certification result reply unit.

Preferably, the body information may include at least one of iris, fingerprint, and face image information, and the anonymity code may include a country code to which a corresponding person belongs and an identification code of the corresponding person, and may be mapped on the basic information to be stored.

Further, the quasi-public syntagmatic certification center according to the aspect of the present invention may further include a registration information processing unit sending registered address information of the corresponding user whose certification is successful to the terminal through the certification result reply unit as the reply in the case where the determined certification result is successful and product transaction information, which includes transaction time information and a company identification number that requests the certification or is requested to perform the certification, is received from a specified terminal, after sending the determined certification result to the corresponding user terminal as the reply.

The present invention has the following effects.

1. When the certification is requested, the quasi-public syntagmatic certification center performs the certification by using the response result that is received in response to whether there is the identity between the resultant code, which is obtained through the setting combination between the private basic key found by the functionality dependent relationship with the terminal identification number and the preset center basic key, and the preset corresponding anonymity code, and the position information, which are sent to the sub lower certification center, and if more detailed certification is required (for example, during financial transactions), the quasi-public syntagmatic certification center performs the certification by additionally requesting the body information (for example, iris, fingerprint, and face image information) of the corresponding user. Accordingly, the user does not feel any inconvenience even if the user does not know any personal information during the certification and the risk according to the certification process is reduced since it is not necessary for any company to have the personal information that impose a burden thereon.

2. Even if the personal identification information of the commonly used basic key concept is open to the public or is abused by one mistake in a state where the personal identification information has been kept well, the risk, which still exists although it is intended to use the substitute basic key, can be eliminated.

3. It is possible to reduce the risk that is caused by accessing the database network by using the information obtained illegally or accidentally on offline.

4. From the person standpoint, it is not required to memorize IDs or passwords to suit the user's convenience. Further, from the company standpoint, it is not required to store the client's personal information, and thus inconvenience and the risk of information exposure can be reduced.

5. It is possible to prevent in advance the personal information transactions between companies.

6. It is possible to process an emergency state promptly, legally, and rationally on offline, and thus the fairness and transparency of the administrative service can be ensured.

7. The objective monitoring system and operation system can operate in a public and transparent manner, and in the case of applying such systems to a cloud computing system, the transparency, fairness, and stability can be guaranteed in the management and operation.

8. The present invention can be applied to the next generation electronic communication network operation such as the latest u-Health M2M ubiquitous, and thus it is possible to provide a system that wipes out the negative causes such as information monopolization, that is, Big Brother, in reality where a system having the rightfulness of using body information is absent.

### BRIEF DESCRIPTION OF THE DRAWINGS

The above and other objects, features and advantages of the present invention will be more apparent from the following detailed description taken in conjunction with the accompanying drawings, in which:

FIG. 1 is a diagram illustrating a system for syntagmatically managing and operating certification using an anonymity code according to an embodiment of the present invention;

FIG. 2 is a block diagram illustrating a quasi-public syntagmatic certification center according to an embodiment of the present invention;

FIGS. 3A and 3B are flowcharts illustrating in order a method for syntagmatically managing and operating certification using an anonymity code according to a first embodiment of the present invention;

FIG. 4 is a flowchart illustrating in order a method for syntagmatically managing and operating certification using an anonymity code according to a second embodiment of the present invention;

FIG. 5 is a flowchart illustrating in order a method for syntagmatically managing and operating certification using an anonymity code according to a third embodiment of the present invention;

FIG. 6 is a diagram illustrating a user position information encryption operation using a public key encryption algorithm according to an embodiment of the present invention; and

FIG. 7 is a diagram illustrating a certification operation that is performed in a second lower certification center.

### DETAILED DESCRIPTION OF THE PREFERRED EMBODIMENTS

Hereinafter, preferred embodiments of the present invention will be described with reference to the accompanying drawings. The matters defined in the description, such as the detailed construction and elements, are nothing but specific details provided to assist those of ordinary skill in the art in a comprehensive understanding of the invention, and thus the present invention is not limited thereto. In the entire description of the present invention, the same drawing reference numerals are used for the same elements across various figures, and well-known functions and configurations are not described in detail since they would obscure the invention in unnecessary detail. In the entire description and claims, the term “comprises” and/or “comprising” means that one or more other components, steps, operations and/or existence or addition of elements are not excluded in addition to the described components, steps, operation and/or elements.

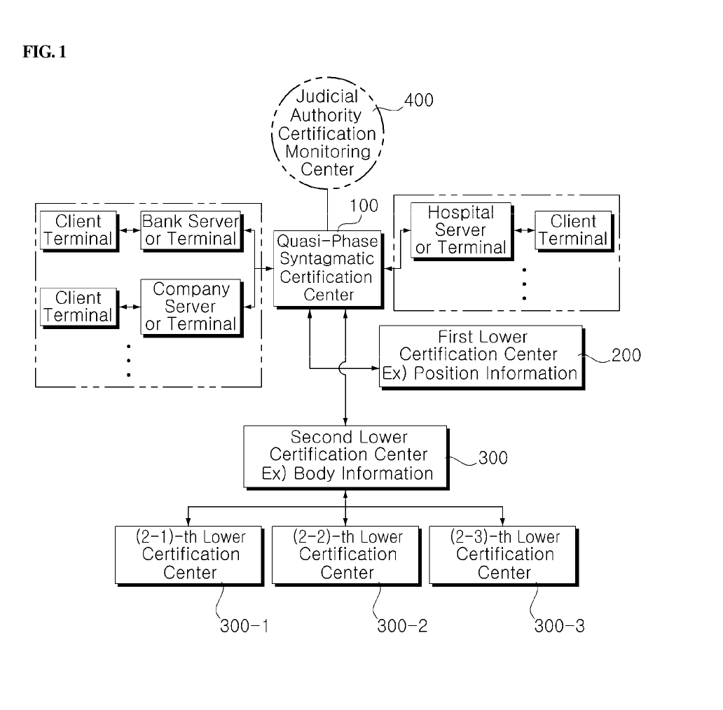

FIG. 1 is a diagram illustrating a system for syntagmatically managing and operating certification using an anonymity code according to an embodiment of the present invention.

As illustrated in FIG. 1, the system includes user terminals (for example, company or corporation terminals, bank terminals, hospital terminals, and the like), a quasi-public syntagmatic certification center 100, a first lower certification center 200, a second lower certification center 300, and a judicial authority certification monitoring center 400.

That is, the system includes the user terminal that requests certification and receives the result of certification, the quasi-public syntagmatic certification center 100 syntagmatically processing the certification using the anonymity code when the user terminal requests the certification and sending the result of processing to the user terminal, the first lower certification center 200 extracting a response code to the basic information (for example, user position information) that is required to determine the certification and informing the quasi-public syntagmatic certification center 100 of the extracted response code, and the second lower certification center 300 extracting a response code for user's body information if more detailed user verification is required and informing the quasi-public syntagmatic certification center 100 of the extracted response code so that the response code can be used during the certification process.

In addition, the system further includes the judicial authority certification monitoring center 400 that performs a certification information monitoring operation for monitoring and tracking the position of the corresponding user by using the information (for example, user position information) certified by the quasi-public syntagmatic certification center 100.

In the system having the above-described configuration, when the certification is requested, the quasi-public syntagmatic certification center 100 performs the certification by using the response result that is received in response to whether there is the identity between the resultant code, which is obtained through the setting combination between the private basic key found by the functionality dependent relationship with the terminal identification number and the preset center basic key, and the preset corresponding anonymity code, and the position information, which are sent to the first lower certification center 200, and if more detailed certification is required (for example, during financial transactions), the quasi-public syntagmatic certification center 100 performs the certification by additionally requesting the body information (for example, iris, fingerprint, and face image information) using the second lower certification center 300. Accordingly, the user does not feel any inconvenience even if the user does not know any personal information during the certification and the risk according to the certification process is reduced since it is not necessary for any company to have the personal information that impose a burden thereon.

Here, when the user terminal (for example, a company or corporation terminal, a bank terminal, a hospital terminal, or a client terminal) requests the certification, the quasi-public syntagmatic certification center 100 receives the basic information that includes the terminal identification number of the corresponding user from the user terminal, determines whether to perform the certification with respect to the certification request from the user terminal depending on whether there is an identity between a first resultant code, which is obtained through setting combination (for example, X+Y) between a private basic key (for example, X) (for reference, the basic key may be, for example, a key that is used for document encryption in an asymmetric cryptosystem) found by the functionality dependent relationship with the received terminal identification number and the preset basic key of the quasi-public syntagmatic certification center (for example: Y), and the preset corresponding anonymity code, and sends the determined certification result to the corresponding user terminal as a reply. For reference, the functionality dependent relationship is a relationship that is obtained by inputting the terminal identification number to a preset function and dependently obtaining the result (here, the personal basic key). Further, the anonymity code is anonymity information that is used in replacement of the personal information (for resident registration number) during the certification, and may be composed of a country code “K” to which the corresponding person belongs such as K-313, and an identification code “313” of the corresponding person. The anonymity code is mapped on the basic information (for example, the terminal identification number of the corresponding client) to be stored.

On the other hand, the basic information may further include user position information in addition to the terminal identification number, and in this case, that is, if the position information of the corresponding user terminal is further included in the basic information in addition to the terminal identification number, the quasi-public syntagmatic certification center 100 determines whether to perform the certification with respect to the certification request from the user terminal depending on whether there is an identity between a second resultant code, which is obtained according to the functionality dependent relationship using the response code that is extracted depending on whether there is the identity between the position information transferred from the user terminal and the position information of the corresponding user detected by the corresponding lower certification center, with the preset corresponding anonymity code (for example, K-313) and whether there is the identity between the first resultant code and the anonymity code, and sends the determined certification result to the corresponding user terminal as the reply.

On the other hand, if more detailed certification is required (for example, during financial transactions), the quasi-public syntagmatic certification center 100 performs the certification by additionally requesting the body information (for example, iris and fingerprint information) in addition to the basic information. For this, the quasi-public syntagmatic certification center 100 requests body information of the corresponding user from the terminal in the case where the quasi-public syntagmatic certification center receives a company identification number from a specified terminal and determines that more detailed certification is required from company identifiable information that is mapped on the received company identification number. The quasi-public syntagmatic certification center 100 transfers the body information of the corresponding user that is received as the request result to the second lower certification center 300, determines whether to perform the certification with respect to the certification request from the user terminal with reference to both whether there is an identity between a third resultant code (for example, C-212), which is obtained according to the functionality dependent relationship using the response code extracted by the second lower certification center 300, and the preset corresponding anonymity code (for example, K-313) and whether there is the identity between the first resultant code and the anonymity code, and informs the user of the determined certification result through sending of the determined certification result to the terminal. At this time, if the position information is further included in the basic information, whether there is the identity between the second resultant code and the anonymity code is also used to determine the certification. On the other hand, the quasi-public syntagmatic certification center sends the determined certification result to the corresponding user terminal as a reply, and if the determined certification result is successful and product transaction information, which includes transaction time information and a company identification number that requests the certification or is requested to perform the certification, is received from a specified terminal, the quasi-public syntagmatic certification center sends the registered address information of the corresponding user whose certification is successful to the terminal as a reply to provide the registered information (for example, client address information during a home delivery service) to the certified user if necessary.

If the user position information is included in the basic information that is required during the certification determination in addition to the terminal identification number, the first lower certification center 200 detects the response result regarding whether the user position information that is transferred from the user terminal through the quasi-public syntagmatic certification center 100 is correct information in a response code form, and informs the quasi-public syntagmatic certification center 100 of the detected response result. More specifically, if the position information of the corresponding user terminal is included in the basic information in addition to the terminal identification number, the first lower certification center 200 extracts the response code according to whether there is an identity between the position information of the user terminal transferred from the quasi-public syntagmatic certification center 100 and the position information of the corresponding user terminal detected by the lower certification center using a GPS (Global Positioning System). The extracted response code is used to determine the user certification, and for example, if the second resultant code that is obtained according to the functionality dependent relationship using the response code (for example, B-212) is equal to the anonymity code (K-313), the user certification is permitted.

If more detailed certification is required (for example, during financial transactions), the second lower certification center 300 performs the certification process through requesting the user body information (for example, iris and fingerprint information) in addition to the basic information, that is, the terminal identification number and the terminal position information. For this, the second lower certification center 300 extracts the response code depending on whether there is the identity between the position information of the user terminal transferred from the quasi-public syntagmatic certification center 100 and the pre-registered body information of the corresponding user. That is, in the case where the quasi-public syntagmatic certification center 100 receives a company identification number from a specified terminal and determines that more detailed certification is required (for example, in the case of a financial transaction company) from company identifiable information that is mapped on the received company identification number, the quasi-public syntagmatic certification center 100 requests body information of the corresponding user from the terminal, and transfers the body information of the corresponding user that is received as the request result to the second lower certification center 300. The second lower certification center 300 extracts the response code depending on whether there is the identity between the body information of the corresponding user that is transferred from the quasi-public syntagmatic certification center 100 and the pre-registered body information of the corresponding user. Then, the quasi-public syntagmatic certification center 100 determines whether to perform the certification with respect to the certification request from the user terminal depending on whether there is the identity between a third resultant code, which is obtained according to the functionality dependent relationship using the extracted response code, and the preset corresponding anonymity code and whether there is the identity between the first resultant code and the anonymity code, and informs the user of the determined certification result through sending of the determined certification result to the terminal. The second lower certification center 300 may be divided into a plurality of lower certification centers, for example, a lower certification center 300-1 to process the iris information and a lower certification center 300-2 to process the fingerprint information, in order to process the detailed information without departing from the technical scope of the present invention.

The judicial authority certification monitoring center 400 performs the certification information monitoring operation for monitoring and tracking the position of the corresponding user by using the information (for example, user position information) certified by the quasi-public syntagmatic certification center 100. The monitored certification information (for example, user position information) may be used for crime prevention or solution.

For reference, in order to protect the personal information in a communication step, the information transmission/reception between the user terminal and the quasi-public syntagmatic certification center and the information transmission/reception between the quasi-public syntagmatic certification center and the lower certification center are performed using a communication protocol in which corresponding anonymity information is coded onto a header portion instead of the personal information.

That is, in order to transfer accurate information in an information transmission step or information reception step, protocols are provided for 7 OSI steps, and during communication of the information according to the respective protocols, a terminal identification IP that is a physical layer is provided in the header portion, and personal information is provided to know who has sent the information. In this case, in order to prevent a risk that is caused by sniffing that occurs in the midway or erroneous address put in the receiving step later, encryption capsulation is performed in diverse methods such as hash function or block cipher REA. However, if the information is decoded by anyone, the personal information is exposed, and thus the anonymous communication network system becomes meaningless. To solve this, the information transmission/reception between the user terminal and the quasi-public syntagmatic certification center and the information transmission/reception between the quasi-public syntagmatic certification center and the lower certification center are performed using the communication protocol in which the corresponding anonymity information is coded onto the header portion instead of the personal information.

Further, the term “anonymity” is defined as follows. That is, instead of making non-technology based personal identification information (for example, a resident registration number, a name, and the like) like technology based non-identification information so as to hide and not to use the information, only technology based identification information (for example, position information and body information) is utilised as the personal information, and thus the personal identification information that is used in the realistic system is prevented from being used.

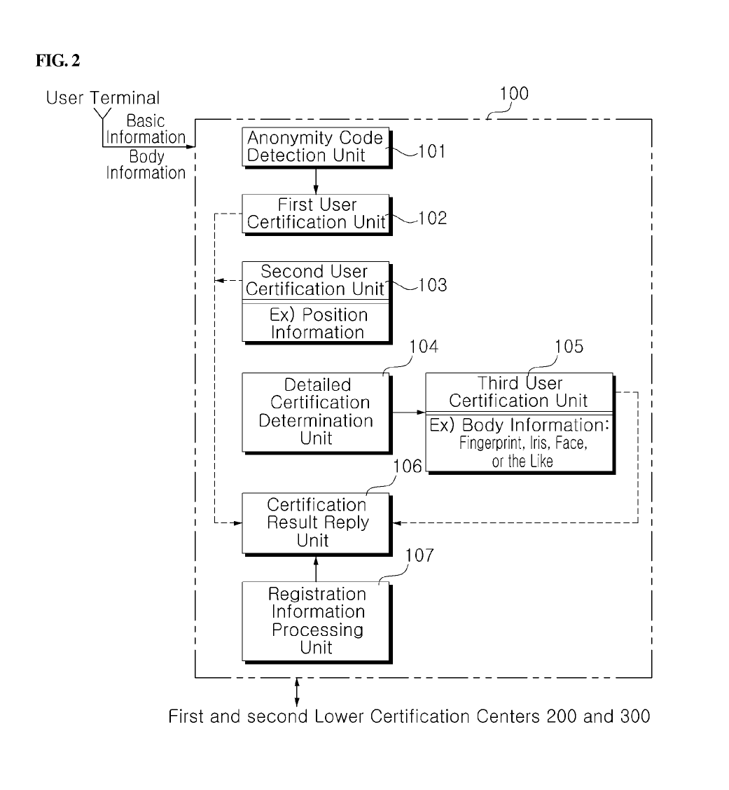

Hereinafter, the quasi-public syntagmatic certification center that constitutes the system for syntagmatically managing and operating certification using an anonymity code according to an embodiment of the present invention as shown in FIG. 1 will be described in detail with reference to FIG. 2.

FIG. 2 is a block diagram illustrating a quasi-public syntagmatic certification center according to an embodiment of the present invention.

As illustrated in FIG. 2, the quasi-public syntagmatic certification center 100 includes an anonymity code detection unit 101, a first user certification unit 102, and a certification result reply unit 106.

In addition, the quasi-public syntagmatic certification center 100 includes a second user certification unit 103, a detailed certification determination unit 104, a third user certification unit 105, and a registration information processing unit 107.

Here, the anonymity code detection unit 101 receives the basic information that includes the terminal identification number from the user terminal when the corresponding user terminal requests certification, and detects whether there is the identity between the first resultant code, which is obtained through the setting combination between the private basic key found by the functionality dependent relationship with received terminal identification number and the preset center basic key (that is, the basic key that is given to the quasi-public syntagmatic certification center), and the preset corresponding anonymity code. The anonymity code is the anonymity information that is used instead of the personal information (for example, resident registration number). For example, the anonymity code may be “K-313” that is composed of a country code “K” to which the corresponding person belongs and an identification code “313” of the corresponding person, and may be mapped on the basic information to be stored in a database (not illustrated) or the like.

The first user certification unit 102 is connected to the anonymity code detection unit 101, and determines whether to perform the certification with respect to the certification request from the user terminal depending on whether there is the identity between the first resultant code detected by the anonymity code detection unit 101 and the anonymity code. For example, if the first resultant code, which is obtained through the setting combination between the private basic key found by the functionality dependent relationship with the terminal identification number, is identical to the preset corresponding anonymity code that is mapped on the terminal identification number, it is determined that the user certification is successful (or permitted), while if the first resultant code is different from the anonymity code, it is determined that the user certification fails (or is intercepted).

The second user certification unit 103 processes the position information of the corresponding user terminal if the position information is further included in the basic information that is necessary for the certification in addition to the terminal identification information. That is, the second user certification unit 103 determines whether to perform the certification with respect to the certification request from the user terminal depending on whether there is the identity between the second resultant code, which is obtained according to the functionality dependent relationship using the response code that is extracted depending on whether there is the identity between the position information of the user terminal transferred from the quasi-public syntagmatic certification center 100 and the position information of the corresponding user detected by the corresponding lower certification center, and the preset corresponding anonymity code and whether there is the identity between the first resultant code (that is, the first resultant code obtained through the setting combination between the private basic key found by the functionality dependent relationship with the terminal identification number and the preset center basic key) and the anonymity code, and sends the determined certification result to the corresponding user terminal through the certification result reply unit 106 as the reply. The determination result is classified into success and failure. In the case of success, the second resultant code, which is obtained according to the functionality dependent relationship using the response code that is extracted by the first lower certification center, is equal to the preset corresponding anonymity code, and the first resultant code, which is obtained through the setting combination between the private basic key found by the functionality dependent relationship with the terminal identification number and the preset center basic key, is equal to the anonymity code. In the case of failure, the resultant code is different from the anonymity code in any one of the two conditions.

The detailed certification determination unit 104 receives the company identification number from a specified terminal, and if it is determined that more detailed certification is required from the company identifiable information that is mapped on the received company identification number, for example, if the company identifiable information that is mapped on the received company identification number is the company identifiable information that performs financial transactions and thus more detailed certification is required, the detailed certification determination unit 104 requests body information (for example, fingerprint or iris information) of the corresponding user (for example, user who requests the certification) from the terminal.

The third user certification unit 105 transfers the body information of the corresponding user that is received as the result of the additional request to the second lower certification center, determines whether to perform the certification with respect to the certification request from the user terminal depending on whether there is an identity between a third resultant code, which is obtained according to the functionality dependent relationship using the response code that is extracted by the second lower certification center depending on whether there is an identity between the transferred body information of the corresponding user and pre-registered body information of the corresponding user, and the preset corresponding anonymity code and whether there is an identity between the first resultant code and the anonymity code, and informs the user of the determined certification result through sending of the determined certification result to the terminal through the certification result reply unit. The determination result is classified into success and failure. In the case of success, the third resultant code, which is obtained according to the functionality dependent relationship using the response code that is extracted by the second lower certification center, is equal to the preset corresponding anonymity code, and the first resultant code, which is obtained through the setting combination between the private basic key found by the functionality dependent relationship with the terminal identification number and the preset center basic key, is equal to the anonymity code. In the case of failure, the resultant code is different from the anonymity code in any one of the two conditions. The body information may include at least one of iris, fingerprint, and face image information. Further, in the case where user terminal position information is further included in the basic information in addition to the terminal identification number, whether there is an identity between the second resultant code and the anonymity code is used to determine whether to performs the certification.

The certification result reply unit 106 interfaces with the user terminal, and informs the user of the determined certification result through sending of the certification result determined through the first to third user certification units 102, 103, and 105 to the corresponding user terminal as a reply.

The registration information processing unit 107 sends the result of the certification determined through the first to third user certification units 102, 103, and 105 to the corresponding user terminal as the reply. Thereafter, if the determined certification result is successful and product transaction information, which includes transaction time information and a company identification number that requests the certification or is requested to perform the certification, is received from a specified terminal, the registration information processing unit 107 sends the registered address information of the corresponding user whose certification is successful to the terminal through the certification result reply unit 106.

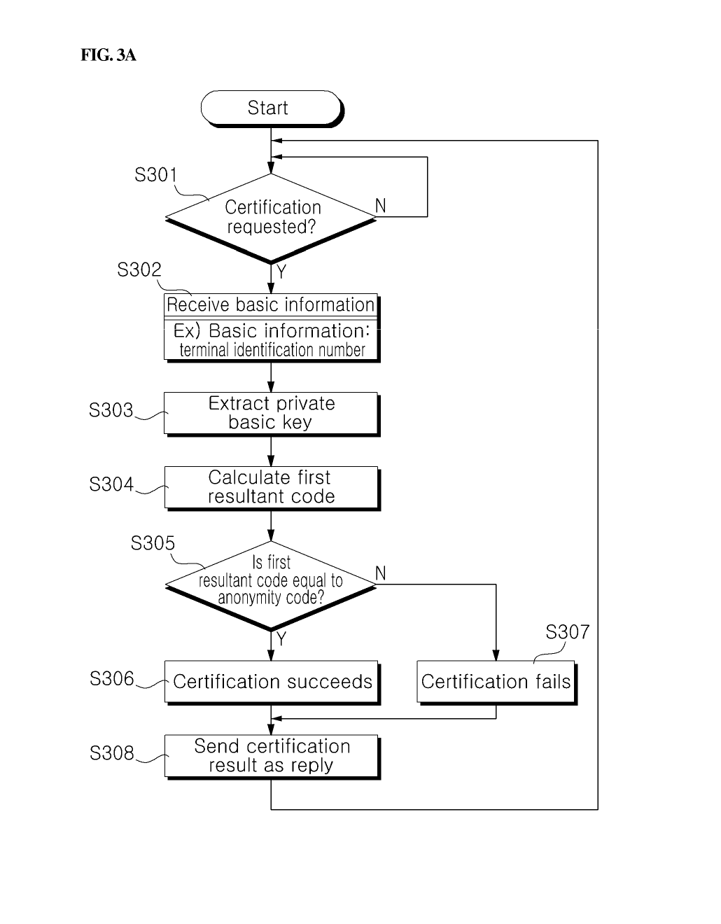

Hereinafter, the operation of the system for syntagmatically managing and operating certification using an anonymity code according to an embodiment of the present invention of FIG. 1 will be described with reference to FIGS. 3A to 3B.

FIGS. 3A and 3B are flowcharts illustrating in order the operation of the system for syntagmatically managing and operating certification using an anonymity code according to an embodiment of the present invention.

As illustrated in FIG. 3A, if the user terminal requests certification (S301), the quasi-public syntagmatic certification center receives the basic information including the terminal identification number from the corresponding user terminal (S302).

Then, the quasi-public syntagmatic certification center determines whether to perform the certification with respect to the certification request from the user terminal depending on whether there is the identity between the first resultant code, which is obtained through the setting combination (for example, X+Y) between the private basic key (for example, X) obtained from the received terminal identification number and the preset center basic key (for example, Y), and the preset corresponding anonymity code (S303 to S307).

For example, if the first resultant code, which is obtained through the setting combination between the private basic key obtained from the received terminal identification number and the preset center basic key, is equal to the preset corresponding anonymity code, it is determined that the user certification is successful (or permitted).

On the other hand, if the first resultant code is different from the anonymity code, it is determined that the user certification fails (or is intercepted).

The quasi-public syntagmatic certification center informs the user of the certification result determined as described above through sending of the determined certification result to the corresponding user terminal as the reply (S308).

The anonymity code may be composed of the country code “K” to which the corresponding person belongs, such as K-313, and the identification code “313” of the corresponding person. The anonymity code is mapped on the basic information (for example, the terminal identification number of the corresponding client) to be stored.

Next, as illustrated in FIG. 3B, according to an embodiment of the present invention, the basic information may further include user position information in addition to the terminal identification number, and in this case, that is, if the position information of the corresponding user terminal is further included in the basic information in addition to the terminal identification number (S309), the following operation is performed.

First, the first lower certification center extracts different response codes depending on whether there is the identity between the position information that is transferred from the user terminal through the quasi-public syntagmatic certification center and the position information of the corresponding user that is directly detected by the first lower certification center (S310 to S312).

Then, the quasi-public syntagmatic certification center receives the response code from the first lower certification center, and for example, determines whether to perform the certification with respect to the certification request from the user terminal depending on whether there is the identity between the second resultant code (for example, B-213), which is obtained according to the functionality dependent relationship (for example, K-313) using the extracted response code (for example, X) and its own private key (for example, Y), and the preset corresponding anonymity code (for example, K-313) and whether there is the identity between the first resultant code and the anonymity code (S313 to S317).

That is, if the second resultant code, which is obtained according to the functionality dependent relationship using the response code extracted by the first lower certification center, is equal to the preset corresponding anonymity code, and the private basic key that is found by the functionality dependent relationship with the terminal identification number is equal to the anonymity code, it is determined that the certification is successful.

On the other hand, if the resultant code is different from the anonymity code in any one of the two conditions, it is determined that the certification fails.

Next, the quasi-public syntagmatic certification center informs the user of the determined certification result through sending of the determined certification result to the corresponding user terminal as the reply (S318).

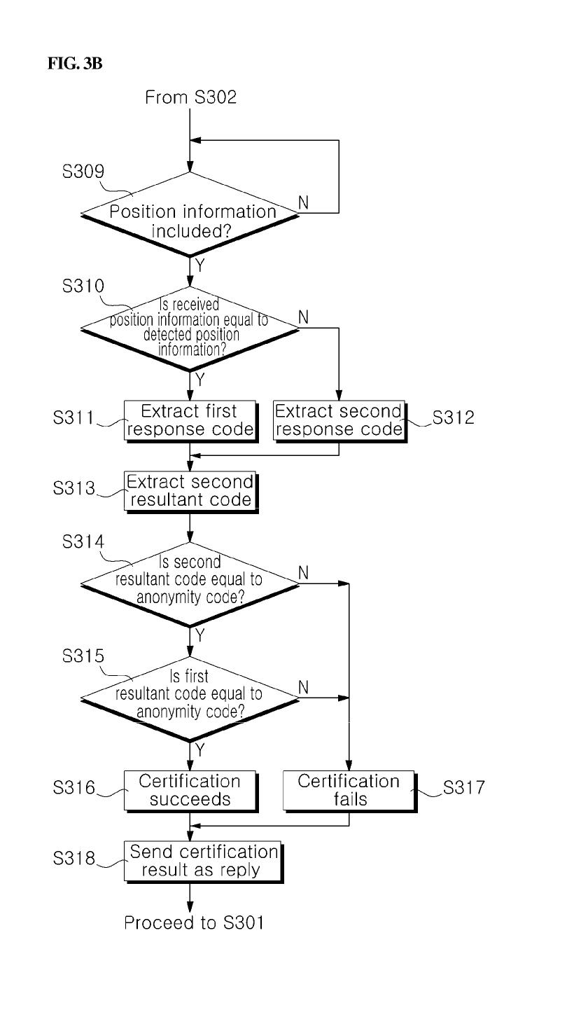

On the other hand, as illustrated in FIG. 4, if more detailed certification is required (for example, during financial transactions), the quasi-public syntagmatic certification center performs the certification by additionally requesting the body information (for example, iris and fingerprint information) in addition to the basic information.

For this, the quasi-public syntagmatic certification center additionally requests the body information of the corresponding user from the terminal in the case where the quasi-public syntagmatic certification center receives the company identification number from the specified terminal and determines that more detailed certification is required from the company identifiable information that is mapped on the received company identification number (S401 to S403).

For example, if the company identifiable information that is mapped on the received company identification number is the identifiable information of the company that performs the financial transactions, the quasi-public syntagmatic certification center determines that more detailed certification is required, and additionally requests the body information (for example, fingerprint and iris information) of the corresponding user (for example, user who requests the certification) from the terminal.

Next, the quasi-public syntagmatic certification center transfers the body information of the corresponding user that is received as the result of the additional request to the second lower certification center, and receives the response code that is extracted by the second lower certification center depending on whether there is the identity between the transferred body information and the pre-registered body information of the corresponding user (S404 to S408).

Then, the quasi-public syntagmatic certification center determines whether to perform the certification with respect to the certification request from the user terminal depending on whether there is the identity between the third resultant code, which is obtained according to the functionality dependent relationship using the transferred response code, and the preset corresponding anonymity code and whether there is the identity between the first resultant code and the anonymity code, and informs the user of the determined certification result through sending of the determined certification result to the terminal (S409 to S414).

The determination result is classified into success and failure. In the case of success, the third resultant code, which is obtained according to the functionality dependent relationship using the response code that is extracted by the second lower certification center, is equal to the preset corresponding anonymity code, and the first resultant code, which is obtained through the setting combination between the private basic key found by the functionality dependent relationship with the terminal identification number and the preset center basic key, is equal to the anonymity code. In the case of failure, the resultant code is different from the anonymity code in any one of the two conditions.

The body information may include at least one of iris, fingerprint, and face image information.

Further, in the case where the user terminal position information is further included in the basic information in addition to the terminal identification number, whether there is the identity between the second resultant code and the anonymity code is used to determine whether to performs the certification.

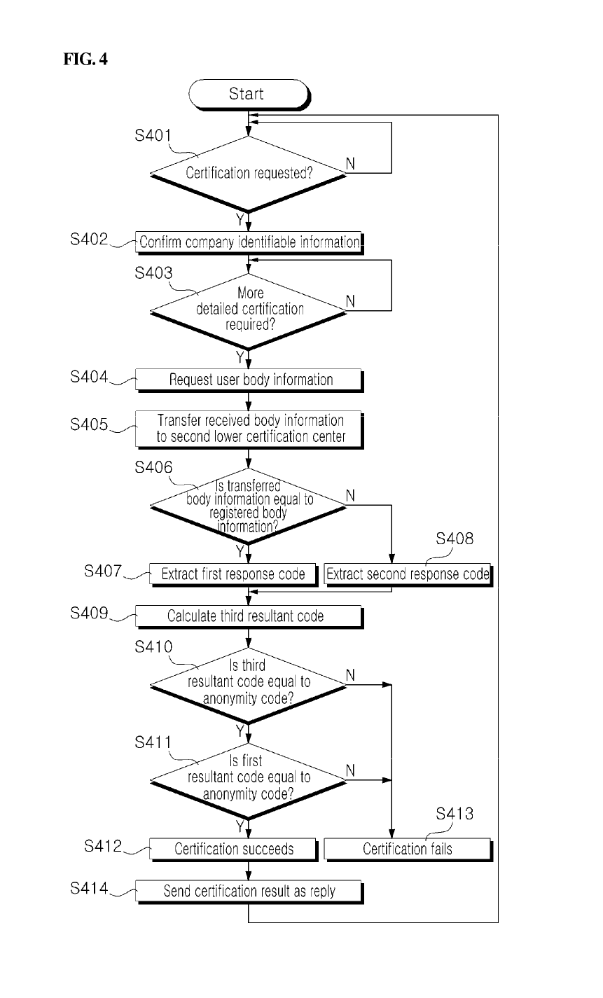

On the other hand, as illustrated in FIG. 5, the quasi-public syntagmatic certification center sends the determined certification result to the corresponding user terminal as the reply, and if the determined certification result is successful and the product transaction information, which includes the transaction time information and the company identification number that requests the certification or is requested to perform the certification, is received from the specified terminal, the quasi-public syntagmatic certification center sends the registered address information of the corresponding user whose certification is successful to the terminal as the reply to provide the registered information (for example, the user address information during the home delivery service) to the certified user if necessary (S501 to S505).

As described above according to the present invention, when the certification is requested, the quasi-public syntagmatic certification center performs the certification by using the response result that is received in response to whether there is the identity between the resultant code, which is obtained through the setting combination between the private basic key found by the functionality dependent relationship with the terminal identification number and the preset center basic key, and the preset corresponding anonymity code, and the position information, which are sent to the sub lower certification center, and if more detailed certification is required (for example, during the financial transactions), the quasi-public syntagmatic certification center performs the certification by additionally requesting the body information (for example, iris, fingerprint, and face image information) of the corresponding user. Accordingly, the user does not feel any inconvenience even if the user does not know any personal information during the certification and the risk according to the certification process is reduced since it is not necessary for any company to have the personal information that impose a burden thereon.

Further, even if the personal identification information of the commonly used basic key concept is open to the public or is abused by one mistake in a state where the personal identification information has been kept well, the risk, which still exists although it is intended to use the substitute basic key, can be eliminated. Further, it is possible to reduce the risk that is caused by accessing the database network by using the information obtained illegally or accidentally on offline. From the person standpoint, it is not required to memorize IDs or passwords to suit the user's convenience, and from the company standpoint, it is not required to store the client's personal information, and thus the inconvenience and the risk of information exposure can be reduced. Further, it is possible to prevent in advance the personal information transactions between companies, and it is possible to process an emergency state promptly, legally, and rationally on offline, and thus the fairness and transparency of the administrative service can be ensured.

For reference, a substantial example of the certification procedure adopting the present invention will be described as follows. It is assumed that a specified user intends to buy a smart phone in a specified company.

1. The user transmits the basic information (a terminal identification number, position information, and time information) to the quasi-public syntagmatic certification center by using a terminal that the user holds.

2. At the same time, the corresponding company transmits the client position information, a company identification number, and time information to the quasi-public syntagmatic certification center using a specified terminal.

3. The quasi-public syntagmatic certification center searches for a private basic key from the basic information.

Then, the quasi-public syntagmatic certification center determines whether to perform certification with respect to the certification request from the user terminal depending on whether there is the identity between the first resultant code, which is obtained through the setting combination (for example, X+Y) between the private basic key (for example, X) and the preset center basic key (for example, Y), and the preset corresponding anonymity code.

4. If it is difficult to confirm the certification through the above-described operation, the quasi-public syntagmatic certification center additionally requests body information, such as user image information (face) or fingerprint, while if the certification can be confirmed through the basic information only, the quasi-public syntagmatic certification center informs the terminal of the company that has requested the certification of the determined certification result.

5. Then, in the case where the certification is successful and the user desires to receive a purchased good by the home delivery service, the corresponding delivery company receives the order information and transmits its company identification number and the product transaction information to the quasi-public syntagmatic certification center in order to obtain the user address.

6. The quasi-public syntagmatic certification center transmits address (or location) information of the user who will receive the delivered good since the certification is successful.

At this time, if the quasi-public syntagmatic certification center is connected to its own geographic information system, it can automatically display the address (or location) information on the specified terminal.

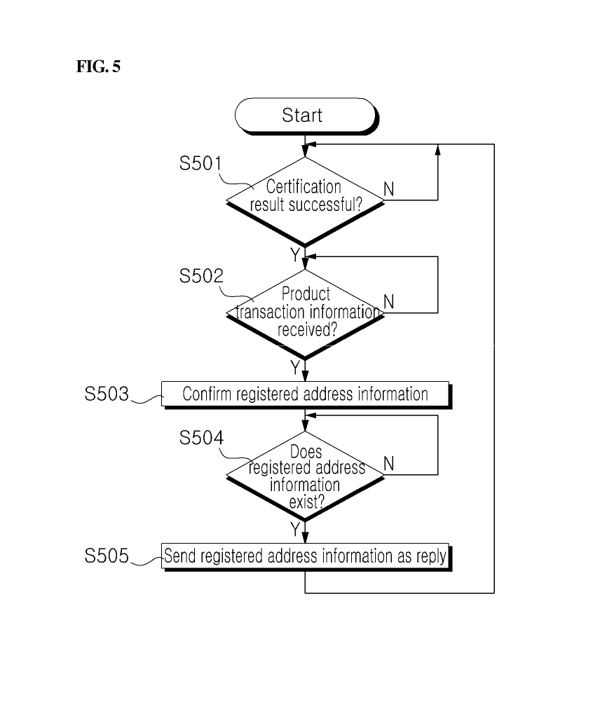

FIG. 6 is a diagram illustrating a user position information encryption operation using a public key encryption algorithm according to an embodiment of the present invention.

As illustrated in FIG. 6, the quasi-public syntagmatic certification center according to the present invention encrypts the basic information of each user (here, for example, user position information) in consideration of the possibility of leakage of the user's basic information. In this case, if the user encrypts the user's sensitive information with a server public key and transfers the information that the user has gathered to the quasi-public syntagmatic certification center, the quasi-public syntagmatic certification center decrypts the corresponding data with its own private key. If the quasi-public syntagmatic certification center performs arithmetic operation using the decrypted value and transfers the resultant value to the user, the user derives the value that corresponds to the user's information.

The public key encryption method is an encryption method using a pair of encryption keys, and has a public key that can be open to the public and a private key that is not open to the public. The data encrypted by the public key can be decrypted by the private key, and the data encrypted by the public key of the corresponding user can be decrypted by the user's private key only. Accordingly, the user's position information encrypted by the public key of the server is not known to the querying user even if the user collects the user's position information, and thus the user's position information can be protected.

The user's encrypted position information collected by the querying user is arranged as an array and is transferred to the quasi-public syntagmatic certification center. The quasi-public syntagmatic certification center decrypts this position information using its own private key, configures the resultant values on the basis of the position information, and sends the resultant values to the querying user in the form of an array set. In this procedure, the quasi-public syntagmatic certification center can obtain information on the respective position areas, but does not know where the querying user is actually present among the various position areas in the form of an array set in probability. Further, since the querying user who has received the resultant values from the query in the form of an array set can extract an accurate value on the basis of the actual position through selection of only the result of the array value for the user's actual position, the user can actually derive desired information on the basis of only the resultant values having low probability among a large number of result sets.

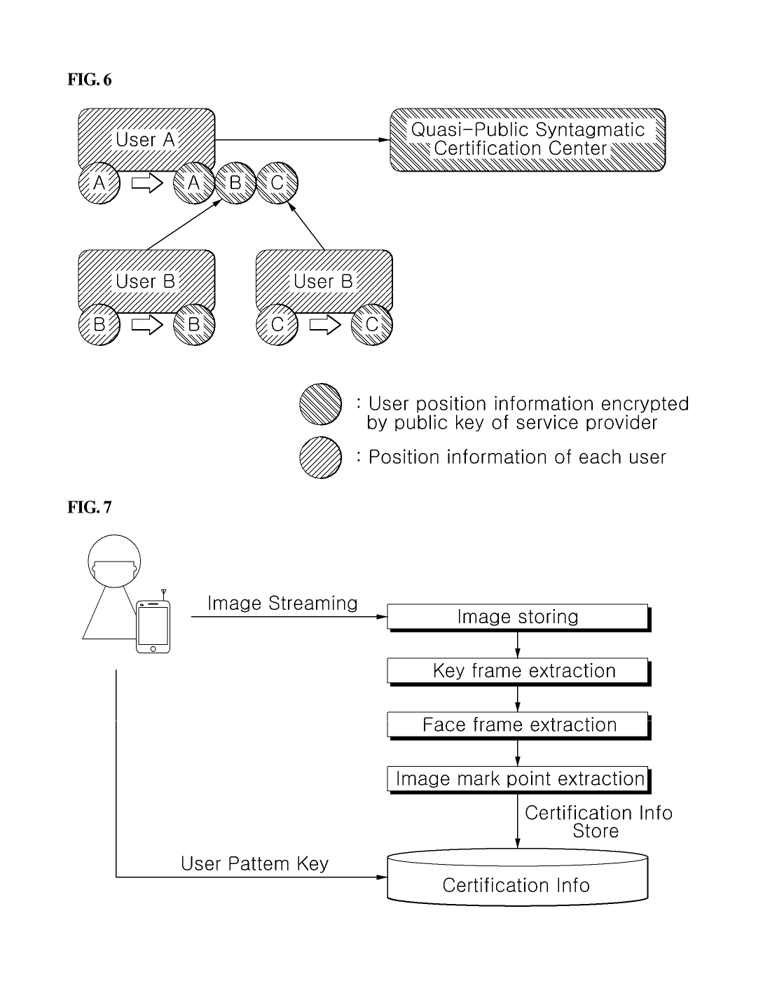

FIG. 7 is a diagram illustrating the certification operation that is performed in the second lower certification center.

As illustrated in FIG. 7, the quasi-public syntagmatic certification center operates a login module for the user certification, and receives a user's image (for example, face image) in streaming manner.

Then, the quasi-public syntagmatic certification center transmits the user's image to the second lower certification center.

The second lower certification center extracts a key frame from the face image. The secret key and the image for the user certification are pre-registered as the certification information.

Further, the second lower certification center extracts a face image from the extracted key frame, finds feature points from the extracted face image area, and stores the feature points in the database together with the user's pattern secret key.

The feature points have position information of eyes, a nose, and a mouth of the face, and information on the positional rate among the respective feature points.

In the case where a moving image is input, the input moving image is scanned from left to right to supplement the drawback of a static image, and the key frame of the input image is extracted through streaming.

In extracting the key frame, a key frame generation method by an image change and a key frame generation method per unit time may be adopted.

The key frame extraction and comparison algorithm is as follows.

The color system of the key frame is converted by sampling, and the converted data is cosine-transformed to be quantized.

Since a data loss occurs in the quantization process, the certification data is extracted by extracting the resultant data that is obtained through a DCT process as the previous data. The resultant data obtained in the DCT process is compressed and managed by Huffman coding.

As the frame comparison algorithm, a DH (Difference of Histogram) comparison algorithm using DC values of chrominance blocks is adopted.

The primary comparison algorithm extracts the DC values of the chrominance blocks of the frame, and compares the value of the certification image key frame with the value of a target key frame as a certain threshold value.

If the resultant value that is obtained through the value comparison is smaller than the threshold value, it is considered that the frames are similar to each other, and the DB (Difference of Brightness) comparison algorithm is applied.

The DB comparison algorithm compares the result, which is obtained through comparison of the certification image frame with the target key frame using pixel values, with the certain threshold value, and if the resultant value is smaller than the threshold value, the DB comparison algorithm finally determines that the frames are similar to each other.

Further, if the resultant value is larger than the threshold value, the DB comparison algorithm recognizes that the frames are similar to each other, and generates a response code for certification of the user as a rightful user.

The key frame comparison is performed in two methods, that is, a comparison method using a pixel value difference and a comparison method using the similarity of color distribution.

The method using the pixel value difference has the characteristic in that it is sensitive to the movement of an object or frame noise, and the method using the DC value of the color block has the inefficiency with respect to an image having various illumination changes.

Although preferred embodiments of the present invention have been described for illustrative purposes, those skilled in the art will appreciate that various modifications, additions and substitutions are possible, without departing from the scope and spirit of the invention as disclosed in the accompanying claims.

1. A method for syntagmatically managing and operating certification using an anonymity code, comprising:
causing a quasi-public syntagmatic certification center to receive basic information including a terminal identification number from a user terminal when the user terminal requests certification;
causing the quasi-public syntagmatic certification center to detect whether there is an identity between a first resultant code, which is obtained through setting combination between a private basic key obtained from the received terminal identification number and a preset center basic key, and a preset corresponding anonymity code;
causing the quasi-public syntagmatic certification center to determine whether to perform the certification with respect to the certification request from the user terminal depending on whether there is the identity between the detected first resultant code and the anonymity code; and
causing the quasi-public syntagmatic certification center to send the determined certification result to the corresponding user terminal as a reply.

2. The method for syntagmatically managing and operating certification according to claim 1, wherein the basic formation further includes position information of the corresponding user terminal in addition to the terminal identification number, and
the method further comprises:
causing the quasi-public syntagmatic certification center to transfer the position information to a lower certification center;
causing the lower certification center to extract a response code depending on whether there is an identity between the position information and position information of the corresponding user that is detected by the corresponding lower certification center;
causing the quasi-public syntagmatic certification center to determine whether to perform the certification with respect to the certification request from the user terminal depending on whether there is an identity between a second resultant code, which is obtained according to a functionality dependent relationship using the extracted response code, and the preset corresponding anonymity code and whether there is the identity between the first resultant code and the anonymity code; and
sending the determined certification result to the corresponding user terminal as the reply.

3. The method for syntagmatically managing and operating certification according to claim 1, further comprising:
causing the quasi-public syntagmatic certification center to request body information of the corresponding user from the terminal in the case where the quasi-public syntagmatic certification center receives a company identification number from a specified terminal and determines that more detailed certification is required from a company identifiable information that is mapped on the received company identification number;
causing the quasi-public syntagmatic certification center to transfer the body information of the corresponding user that is received as the request result to a lower certification center;
causing the lower certification center to extract a response code depending on whether there is an identity between the transferred body information of the corresponding user and pre-registered body information of the corresponding user;
causing the quasi-public syntagmatic certification center to determine whether to perform the certification with respect to the certification request from the user terminal depending on whether there is an identity between a third resultant code, which is obtained according to a functionality dependent relationship using the extracted response code, and the preset corresponding anonymity code and whether there is the identity between the first resultant code and the anonymity code; and
informing the user of the determined certification result through sending of the determined certification result to the terminal through the quasi-public syntagmatic certification center.

4. The method for syntagmatically managing and operating certification according to claim 3, wherein the body information includes at least one of iris, fingerprint, and face image information.

5. The method for syntagmatically managing and operating certification according to claim 1, wherein the anonymity code includes a country code to which a corresponding person belongs and an identification code of the corresponding person, and is mapped on the basic information to be stored.

6. The method for syntagmatically managing and operating certification according to claim 1, further comprising, after sending the determined certification result to the corresponding user terminal as a reply, sending registered address information of the corresponding user whose certification is successful to the terminal as a reply in the case where the determined certification result is successful and the quasi-public syntagmatic certification center receives product transaction information, which includes transaction time information and a company identification number that requests the certification or is requested to perform the certification, from a specified terminal.

7. The method for syntagmatically managing and operating certification according to claim 1, wherein information transmission/reception between the user terminal and the quasi-public syntagmatic certification center and information transmission/reception between the quasi-public syntagmatic certification center and the lower certification center are performed using a communication protocol in which corresponding anonymity information is coded onto a header portion instead of the personal information.

8. A system for syntagmatically managing and operating certification using an anonymity code, comprising:
a user terminal; and
a quasi-public syntagmatic certification center receiving basic information including a terminal identification number from a user terminal when the user terminal requests certification, determining whether to perform the certification with respect to the certification request from the user terminal depending on whether there is an identity between a first resultant code, which is obtained through setting combination between a private basic key obtained from the received terminal identification number and a preset center basic key, and a preset corresponding anonymity code, and sending the determined certification result to the corresponding user terminal as a reply.

9. The system for syntagmatically managing and operating certification according to claim 8, wherein the basic information further includes position information of the corresponding user terminal in addition to the terminal identification number, and
the system further comprises a first lower certification center extracting a response code depending on whether there is an identity between the position information transferred from the quasi-public syntagmatic certification center and position information of the corresponding user that is detected by the corresponding lower certification center,
wherein the quasi-public syntagmatic certification center determines whether to perform the certification with respect to the certification request from the user terminal depending on whether there is an identity between a second resultant code, which is obtained according to a functionality dependent relationship using the extracted response code, and the preset corresponding anonymity code and whether there is the identity between the first resultant code and the anonymity code, and sends the determined certification result to the corresponding user terminal as the reply.

10. The system for syntagmatically managing and operating certification according to claim 8, further comprising a second lower certification center extracting a response code depending on whether there is an identity between the body information of the corresponding user that is transferred from the quasi-public syntagmatic certification center and pre-registered body information of the corresponding user,
wherein the quasi-public syntagmatic certification center requests the body information of the corresponding user from the terminal in the case where the quasi-public syntagmatic certification center receives a company identification number from a specified terminal and determines that more detailed certification is required from a company identifiable information that is mapped on the received company identification number, transfers the body information of the corresponding user that is received as the request result to the lower certification center, determines whether to perform the certification with respect to the certification request from the user terminal depending on whether there is an identity between a third resultant code, which is obtained according to a functionality dependent relationship using the response code extracted by the second lower certification center, and the preset corresponding anonymity code and whether there is the identity between the first resultant code and the anonymity code, and informs the user of the determined certification result through sending of the determined certification result to the terminal.

11. The system for syntagmatically managing and operating certification according to claim 10, wherein the body information includes at least one of iris, fingerprint, and face image information.

12. The system for syntagmatically managing and operating certification according to claim 8, wherein the anonymity code includes a country code to which a corresponding person belongs and an identification code of the corresponding person, and is mapped on the basic information to be stored.

13. The system for syntagmatically managing and operating certification according to claim 8, wherein the quasi-public syntagmatic certification center sends registered address information of the corresponding user whose certification is successful to the terminal as a reply in the case where the determined certification result is successful and product transaction information, which includes transaction time information and a company identification number that requests the certification or is requested to perform the certification, is received from a specified terminal system, after sending the determined certification result to the corresponding user terminal as a reply.

14. The method for syntagmatically managing and operating certification according to claim 9, further comprising a judicial authority certification monitoring center performing a certification information monitoring operation for monitoring and tracking the position of the corresponding user by using the information certified by the quasi-public syntagmatic certification center.

15. The method for syntagmatically managing and operating certification according to claim 8, wherein information transmission/reception between the user terminal and the quasi-public syntagmatic certification center and information transmission/reception between the quasi-public syntagmatic certification center and the lower certification center are performed using a communication protocol in which corresponding anonymity information is coded onto a header portion instead of the personal information.

16. A quasi-public syntagmatic certification center comprising:
an anonymity code detection unit detecting whether there is an identity between a first resultant code, which is obtained through setting combination between a private basic key obtained from a terminal identification number received from a corresponding user terminal when the user terminal requests certification and a preset center basic key, and a preset corresponding anonymity code;
a first user certification unit determining whether to perform the certification with respect to the certification request from the user terminal depending on whether there is the identity between the detected first resultant code and the anonymity code; and
a certification result reply unit sending the determined certification result to the corresponding user terminal as a reply.

17. The quasi-public syntagmatic certification center according to claim 16, wherein the basic information further includes position information of the corresponding user terminal in addition to the terminal identification number, and
the quasi-public syntagmatic certification center further comprises a second user certification unit system determining whether to perform the certification with respect to the certification request from the user terminal depending on whether there is an identity between a second resultant code, which is obtained according to a functionality dependent relationship using a response code that is extracted depending on whether there is an identity between the position information transferred from the quasi-public syntagmatic certification center and position information of the corresponding user that is detected by the corresponding lower certification center, and the preset corresponding anonymity code and whether there is the identity between the first resultant code and the anonymity code, and sending the determined certification result to the corresponding user terminal through the certification result reply unit as the reply.

18. The quasi-public syntagmatic certification center according to claim 16, further comprising:
a detailed certification determination module requesting body information of the corresponding user from the terminal in the case where a company identification number is received from a specified terminal and it is determined that more detailed certification is required from a company identifiable information that is mapped on the received company identification number; and
a third user certification unit transferring the body information of the corresponding user that is received as the request result to a second lower certification center, determining whether to perform the certification with respect to the certification request from the user terminal depending on whether there is an identity between a third resultant code, which is obtained according to a functionality dependent relationship using a response code that is extracted by the second lower certification center depending on whether there is an identity between the transferred body information of the corresponding user and pre-registered body information of the corresponding user, and the preset corresponding anonymity code and whether there is the identity between the first resultant code and the anonymity code, and informing the user of the determined certification result through sending of the determined certification result to the terminal through the certification result reply unit.

19. The quasi-public syntagmatic certification center according to claim 18, wherein the body information includes at least one of iris, fingerprint, and face image information.

20. The quasi-public syntagmatic certification center according to claim 16, wherein the anonymity code includes a country code to which a corresponding person belongs and an identification code of the corresponding person, and is mapped on the basic information to be stored.

21. The quasi-public syntagmatic certification center as claimed in claim 16, further comprising a registration information processing unit sending registered address information of the corresponding user whose certification is successful to the terminal through the certification result reply unit as the reply in the case where the determined certification result is successful and product transaction information, which includes transaction time information and a company identification number that requests the certification or is requested to perform the certification, is received from a specified terminal, after sending the determined certification result to the corresponding user terminal as the reply.
